(19) United States
(12) Patent Application Publication
(10) Pub. No.: US 2024/0413360 A1
(43) Pub. Date: Dec. 12, 2024

(54) FUEL-CELL SYSTEM FOR A VEHICLE, AND METHOD FOR OPERATING SAID SYSTEM

(71) Applicant: ZF Friedrichshafen AG, Friedrichshafen (DE)

(72) Inventors: Raphael Zwick, Wangen (DE); Arne Knoblauch, Friedrichshafen (DE)

(73) Assignee: ZF Friedrichshafen AG, Friedrichshafen (DE)

(21) Appl. No.: 18/701,022

(22) PCT Filed: Sep. 28, 2022
(86) PCT No.: PCT/EP2022/076927

§ 371 Date: Apr. 12, 2024

(30) Foreign Application Priority Data
Oct. 13, 2021 (DE) 10 2021 211 527.6

(51) Int. Cl. H01M 8/04089; H01M 8/04111; H01M 8/04225; H01M 8/04228; H01M 8/04302; H01M 8/04303; H01M 8/04537; H01M 8/04746

(52) U.S. Cl. CPC H01M 8/04104; H01M 8/04111; H01M 8/04225; H01M 8/04228; H01M 8/04302; H01M 8/04303; H01M 8/04619; H01M 8/04761; H01M 2250/20

(57) ABSTRACT

A fuel cell system (100) is provided for a vehicle, in particular for a commercial vehicle (200), having a fuel cell (1) with a cathode-side inlet (3) and a cathode-side outlet (5), a compressor (7) connected in a fluid-conducting manner to the inlet (3) of the fuel cell (1) and having a compressor shaft (9), an expander (11) with an expander shaft (13) and is connected in a fluid-conducting manner to the outlet of the fuel cell (1), and a control unit arrangement (25) for actuating the compressor (7) and the expander (11), where the expander shaft (13) and the compressor shaft (9) are mechanically decoupled from one another. Also disclosed is a control unit arrangement (25) configured to directly influence the operating state of the fuel cell system (100) by actuating the expander (11).

### RELATED APPLICATIONS

This application claims the benefit under 35 U.S.C. § 371 as a U.S. National Phase Application of application no. PCT/EP2022/076927, filed on 28 Sep. 2022, which claims the benefit of German Patent Application no. 10 2021 211 527.6 filed on 13 Oct. 2021, the contents of which are hereby incorporated herein by reference in their entireties.

### FIELD OF THE DISCLOSURE

The present invention relates to a fuel cell system for a vehicle, in particular for a commercial vehicle, having a fuel cell with a cathode-side inlet and a cathode-side outlet, a compressor which is connected in a fluid-conducting manner to the inlet of the fuel cell and having a compressor shaft, an expander which has an expander shaft and is connected in a fluid-conducting manner to the outlet of the fuel cell, and a control unit arrangement for actuating the compressor and the expander, wherein the expander shaft and the compressor shaft are mechanically decoupled from one another.

### SUMMARY

Fuel cell systems of the aforementioned type are generally known. In these fuel cell systems, the compressor is used to draw in air, compress it, and feed it to the cathode-side inlet of the fuel cell to carry out the fuel cell reaction. The compressed substance mixture passes through the fuel cell stack(s). The substance mixture remaining after the reaction exits the outlet of the fuel cell on the cathode side as a gaseous fluid flow. This fluid flow usually still has an overpressure compared to the environment and is therefore used in most fuel cell systems to influence the reactant balance in the fuel cell as dynamic pressure and/or to drive the expander shaft of the expander. In the expander, the substance mixture exiting on the outlet side can be expanded to ambient pressure, and the energy transferred to the expander shaft is usually converted into electrical energy if the expander is connected to a generator.

It is known from the state of the art to make the electrical energy generated by the expander available to the vehicle's electrical system and sometimes also to make this electrical energy accessible to the fuel cell system.

In addition, it is known to operate the expander at different operating points in order to maximize the energy yield from the fluid flow exiting the cathode side, depending on the operating point of the fuel cell located upstream. However, there is a desire to further improve the efficiency in the operation of a fuel cell system.

### SUMMARY

Thus, the invention is based on the task of specifying a fuel cell system of the type described in the beginning, which mitigates the disadvantages perceived in the prior art as far as possible. In particular, the invention is based on the task of providing a fuel cell system which has an improved and/or enhanced performance and/or economy.

The invention solves the task on which it is based in a fuel cell system of the type described at the beginning in that the control unit arrangement is configured to directly influence the operating state of the fuel cell system of the expander. The invention is based on the realization that an independent arrangement of the expander shaft and the compressor shaft makes it possible to operate and control the expander shaft independently of the compressor shaft. The rotational speed of the expander shaft has a direct fluid mechanical influence on the fluid flow that is supplied to the fuel cell by the compressor and passes through the fuel cell, so that actuating the expander shaft independently also has a direct fluid mechanical effect on the fuel cell and the compressor. This allows various operating states of the fuel cell system to be supported without the need for additional hardware. The ability of the expander to convert absorbed mechanical energy into electrical energy and make it available to the fuel cell system or other vehicle components remains fundamentally unaffected.

In a preferred further development, the expander has an idle operating mode, and the control unit arrangement is set up to switch the expander to the idle operating mode during an acceleration process of the compressor. This further development relates to an operating state of the fuel cell system in which the power output of the fuel cell system is to be increased, for example from standstill. In order to generate a higher power output, the fuel cell system requires more air supply on the cathode side, so that the compressor must provide more compression power. To achieve this, the compressor shaft must be driven at a higher speed. Due to the masses to be moved and the nature of the chemical process in the fuel cell, such an acceleration process has been comparatively sluggish in the prior art, and this inertia is increased by the fact that the compressor has to work against the fluid mechanical resistance that the expander, among other things, presents to it. In practice, this represents a limit to the dynamics in driving mode. By operating the expander at idling speed during the acceleration process, i.e., while the speed of the compressor shaft increases, the dynamic pressure at the outlet of the fuel cell decreases, which also means that the compressor has to work against less air resistance if it wants to implement the acceleration. The compressor is accelerated more quickly to the required speed when the expander is operated at idle, which results in significantly more dynamic operation of the fuel cell overall. Once the acceleration process has been completed, the expander can then be switched back to normal operating mode, wherein it absorbs mechanical energy from the substance mixture exiting on the outlet side and converts it into electrical energy, wherein the substance mixture is expanded. In addition, wear in the compressor is reduced because the bearings, in particular air bearings, have already reached the desired speed after a relatively small number of rotations and consequently reach their critical lift-off speed more quickly when accelerating from a standstill, above which wear no longer occurs to any significant extent.

The idle operating mode is characterized by the fact that the expander does not absorb any mechanical energy from the outlet flow of the fuel cell in this operating mode. This can be achieved by the control unit arrangement controlling the expander such that no electrical power is generated by any electrical machine that is actively connected to the expander. Although the shaft and the rotor of the expander must then be moved as inert masses, no additional resistance occurs in the electrical machine.

Alternatively, the escaping substance mixture can be routed past the inlet of the expander via one or more valves, for example directly into the environment.

In a further embodiment, an expander with pitchable rotor blades can be used on the expander shaft, which can be set to spin or standstill by adjusting the blades accordingly.

Alternatively, or additionally, if the expander is coupled to an electrical machine, the mechanical connection between the expander shaft and the electrical machine can be suspended, for example by means of a corresponding clutch, so that the expander shaft can continue to rotate but does so essentially without resistance.

In preferred embodiments, the expander is configured to be operated at a variable operating point. Due to the fact that the expander is to a certain extent located in the exhaust tract of the fuel cell, its operating point can lie in the entire operating range, i.e., from 0% to 100% of the nominal power of the expander, depending on the actuating of the expander.

For the operating state of an increasing power requirement for the fuel cell system already described above, in a further preferred embodiment it can be provided that the control unit arrangement is configured to operate the expander at an operating point in a lower end range of its rated power during an acceleration process of the compressor, preferably in a range of 0% to 30% of its rated power.

In a further preferred embodiment, the control unit arrangement is configured to operate the expander at an operating point in an upper partial region or end region of its rated power during a deceleration process of the compressor, preferably in a region of 50% to 100% of its rated power, further preferably in a region of 60% to 80% of its rated power. As an alternative or in addition to the previous range selection, the upper partial range or upper end range is preferably limited on the upper side by a maximum permissible outlet-side dynamic pressure on the fuel cell in order to avoid unwanted premature aging or damage to the fuel cell.

This embodiment describes an operating state of the fuel cell system in which the power demand on the fuel cell decreases, which means that less air has to be supplied and consequently the compressor can/must be operated at a lower speed.

This embodiment can also be used to decelerate the compressor to a standstill when the fuel cell system is switched off. Particularly when the compressor is completely braked to a standstill, signs of wear occur in the compressor because the speed of the compressor shaft drops below the lift-off speed at a certain point. The lift-off speed characterizes the air bearings frequently used in compressors, and in particular their transition from a slide bearing to an aerodynamic bearing. The faster the braking process is realized, i.e., the lower the number of grinding revolutions in plain bearing operation, the lower the wear of the bearing.

In a further preferred embodiment, the control unit arrangement is configured to control, preferably regulate, the operating point of the expander for setting a desired outlet-side dynamic pressure between the fuel cell and the expander. In practice, the dynamic pressure downstream of the fuel cell on the outlet side also serves to reduce reactant depletion on the cathode side in a fuel cell with several stacks for the stacks that pass through later. Experience has shown that the higher the dynamic pressure, the better it is possible to ensure sufficient cathode-side reactant supply for the later stacks from a fuel cell. In the context of balancing the reaction components, the dynamic pressure is therefore an important control parameter. In most fuel cell systems, this task is performed by a throttle valve or a pressure control valve. With the embodiment according to the invention, it is possible to take over the function of this throttle valve or the pressure control valve in the event of a defect by appropriate control interventions at the operating point of the expander, at least provisionally, as a so-called limp-home function. With appropriate dimensioning of the expander, however, it is also possible to dispense with the throttle valve or the pressure control valve and to transfer the function completely to the expander. It is also a preferred embodiment of the invention to make the installation of a throttle valve or a pressure control valve in the fuel cell system otherwise superfluous by assigning such a throttle valve or a pressure control valve on the inlet side to the expander itself and then controlling it from the control unit arrangement.

In a further preferred embodiment, the expander is coupled to an electric motor by means of the expander shaft, wherein the electric motor can be operated either as a motor or as a generator. The control unit arrangement is configured to control the electric motor in a normal operating mode to drive the generator and in an auxiliary mode as a motor. This embodiment relates to an operating state of the fuel cell system in which the compressor cannot provide enough power or has failed. In such a case, the expander can become an additional compressed air supplier by actuating the electrical machine and fluidically interconnecting the energy-skimming instrument in the appropriate way. As the electric motor drives the expander shaft, the rotor blades arranged on the expander shaft can work like a compressor and compress the air drawn in from the environment and feed it to the fuel cell or the compressor. If the compressor is still functional, both can be operated together as a multi-stage or additive compressor arrangement.

In a further preferred embodiment, in which the expander is coupled to an electric motor by means of the expander shaft, wherein the electric motor can be operated either as a motor or as a generator, the control unit arrangement is configured to control the electric motor as a motor during an acceleration process of the compressor. This reduces the dynamic pressure on the outlet side of the fuel cell, similar to idle operating mode, and the compressor reaches its target speed more quickly.

Preferably, a multi-port valve is provided in the fuel cell system for selective fluid-conducting connection of the inlet of the expander to the outlet of the fuel cell or to the inlet of the fuel cell, wherein the control unit arrangement is configured to control the multi-port valve such that in normal operating mode the inlet of the expander is connected to the outlet of the fuel cell, and in auxiliary mode the inlet of the expander, which then serves as an outlet, is connected in a fluid-conducting manner to the inlet of the fuel cell or the inlet of the compressor.

The independent mounting and actuating of the compressor and expander have further advantages. For example, in a further preferred embodiment, the expander is designed to operate at lower speeds in its operating range than the compressor in its operating range, where in particular the speed of the expander at rated power is lower than the speed of the compressor at rated power. The expander can be designed differently to the compressor if the actuating system is flexible compared to the compressor, so that it operates at lower speeds as a matter of principle. The difference in speed can amount to several tens of thousands of revolutions per minute, in contrast to a common bearing of both systems, so that with an appropriate design of the expander, it is sometimes possible to switch to a more favorable bearing type of the expander shaft, for example to rolling bearings instead of the aerostatic or aerodynamic air bearings, which are structurally complex. This makes the system even more economical without any reduction in performance.

In another preferred embodiment, the control unit arrangement has a first control unit for controlling the compressor and a second control unit for controlling the expander. The two control units are preferably connected to each other in a signal-conducting manner. They can be accommodated in a common housing or in several individual housings.

The control unit arrangement can be made up entirely of dedicated control units, or it can be partially or fully integrated into other control units already present in the vehicle system, either in terms of hardware or software as a corresponding function module.

For example, the control unit arrangement can be partially or fully integrated into the fuel cell control, the compressor control, the expander control, or into the control of a DC/DC converter for the fuel cell system. The DC/DC converter is configured to adapt the voltage generated by the fuel cell to a predetermined voltage for the on-board electrical system of the commercial vehicle. The background to this is that the fuel cell has ohmic properties, i.e., it has the lowest voltage at full load. However, because the vehicle electrical system requires a largely constant voltage, a DC/DC converter is preferably connected between the vehicle electrical system and the fuel cell. It ensures that the load-dependent voltage of the fuel cell is always converted to the vehicle electrical system voltage. Many components in a DC/DC converter and the power electronics of a compressor—such as an inverter—and/or an expander are the same. Physical integration can therefore reduce component redundancies.

As an alternative to the multi-unit solution described above, the control unit arrangement can also have a single control unit for controlling the compressor and the expander. Again, the control unit arrangement can be designed as a dedicated control unit in the manner described above, or it can be implemented in hardware or software in one of the control units from the commercial vehicle system, see in this respect the above explanations.

The invention has been described above by means of a first aspect with reference to the fuel cell system according to the invention. The invention has been described above by means of a first aspect with reference to the fuel cell system according to the invention. In a second aspect, the invention further relates to a method for operating a fuel cell system, in particular a fuel cell system for a vehicle, in particular a commercial vehicle, having a fuel cell with a cathode-side inlet and a cathode-side outlet, a compressor which is connected in a fluid-conducting manner to the inlet of the fuel cell and has a compressor shaft, an expander which has an expander shaft and is connected in a fluid-conducting manner to the outlet of the fuel cell, and a control unit arrangement for actuating the compressor and the expander, wherein the expander shaft and the compressor shaft are mechanically decoupled from one another.

The invention solves the task on which it is based, as described at the beginning, in such a method, in that the method comprises actuating the compressor and the expander, and the expander is actuated such that an operating state of the fuel cell system is directly influenced. The invention relates in particular to a method for operating a fuel cell system according to one of the preferred embodiments described above.

The method according to the invention in the second aspect makes use of the same advantages and the same effects as the fuel cell system according to the invention in the first aspect. Preferred embodiments of the fuel cell system are also preferred embodiments of the method and vice versa. In this respect, reference is therefore also made to the above embodiments.

The method is advantageously further developed by one, more, or all of the following steps:
switching the expander to idle operating mode when the compressor is accelerated;
operating the expander at a variable operating point;
operating the expander at an operating point in a lower end range of its rated power, preferably in a region of 0% to 30% of its rated power when the compressor is accelerated;
operating the expander at an operating point in an upper end range of its rated power, preferably in a region of 50% to 100% of its rated power, when the compressor is decelerated;
controlling, preferably regulating, the operating point of the expander for setting a desired outlet-side dynamic pressure between the fuel cell and the expander;
actuating an electric motor coupled to the expander either in a normal operating mode as a generator or in an auxiliary mode as a motor;
actuating a multi-port valve such that in normal operating mode the inlet of the expander is connected to the outlet of the fuel cell, and in auxiliary mode the inlet of the expander, which then serves as an outlet, is connected to the inlet of the fuel cell or the inlet of the compressor.

In a further aspect, the invention relates to a control unit arrangement for a fuel cell system of a vehicle, in particular for a fuel cell system having a fuel cell with a cathode-side inlet and a cathode-side outlet, a compressor which is connected in a fluid-conducting manner to the inlet of the fuel cell and has a compressor shaft, an expander which has an expander shaft and is connected in a fluid-conducting manner to the outlet of the fuel cell, and a control unit arrangement for actuating the compressor and the expander, wherein the expander shaft and the compressor shaft are mechanically decoupled from one another.

The invention solves the task on which it is based in such a control unit arrangement in that the control unit arrangement is configured to carry out the method according to one of the embodiments described above. In particular, the control unit arrangement is also configured to control a fuel cell system according to one of the embodiments described above.

The control unit arrangement according to this aspect of the invention makes use of the same advantages and effects as the fuel cell system according to the invention and the method according to the invention. The preferred embodiments of the fuel cell system and the method are also preferred embodiments of the control unit arrangement and vice versa. To avoid repetition, reference is made in this respect to the above embodiments.

In the following, the invention is described in more detail by means of a preferred exemplary embodiment with reference to the attached figure.

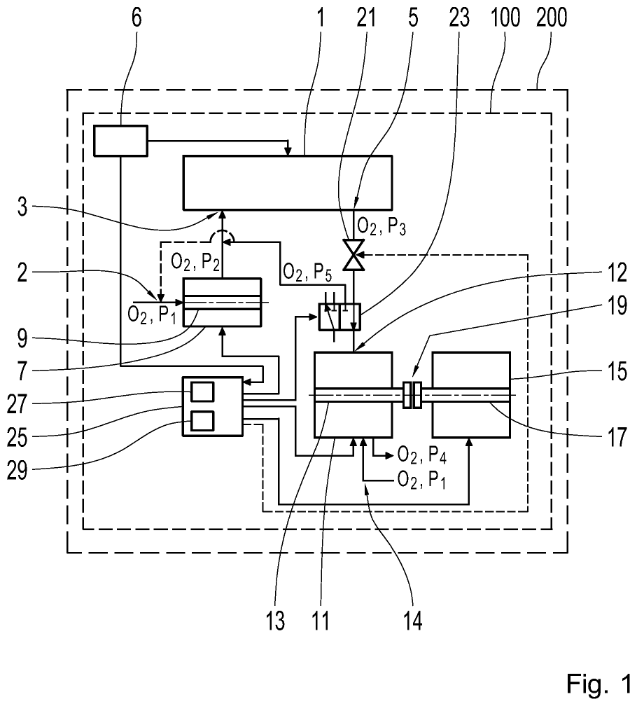

FIG. 1 is the sole figure and shows a schematic representation of a commercial vehicle with a fuel cell system according to a preferred embodiment.

FIG. 1 shows a commercial vehicle 200 with a fuel cell system 100. The fuel cell system 100 has a fuel cell with a cathode-side inlet 3 and a cathode-side outlet 5. Inlet 3 is intended for the supply of air on the cathode side. The reference symbol O₂ is used for the supplied air, wherein it is to be understood that pure oxygen does not have to be supplied, but that oxygen-containing substance mixtures can be used, which in addition to oxygen can also contain other gaseous components such as nitrogen, noble gases, and other components. Ambient air, for example, can be supplied as a substance mixture.

Hydrogen is supplied to the fuel cell 1 on the anode side, but this is not shown here in order to focus on the essential features of the invention.

A substance mixture depleted of the reacted components emerges from the outlet 5 as an exhaust air fluid flow O₂′ from the fuel cell 1.

To feed the air O₂ to the fuel cell 1, the fuel cell system 100 has a compressor 7 with a rotationally driven compressor shaft 9. The compressor 7 is set up to draw in air at a first pressure p₁, for example ambient pressure, compress it, and deliver it to the inlet 3 of the fuel cell 1 at a pressure p₂ that is increased in accordance with the compressor output.

The fuel cell system 100 also has an expander 11, which is mechanically decoupled from the compressor 7. The compressor 7 and the expander 11 are shown offset in the figure for illustration purposes. The mechanical decoupling provides extensive flexibility with regard to the positioning of the compressor 7 and the expander 11 relative to the fuel cell 1 and relative to each other. The compressor 11 and expander 7 can be arranged in a common housing, but they can also be arranged in separate, dedicated housings on the fuel cell 1 or separately from the fuel cell 1.

The expander 11 has an expander shaft 13, which is configured to absorb mechanical energy from the exhaust air flow of the fuel cell 1 by means of rotor blades (not shown in detail) and to set the expander shaft 13 in rotation. For this purpose, the expander 11 has an inlet 12, via which the expander 11 is connected to the outlet 5 of the fuel cell 1 in a fluid-conducting manner. As a result of the energy transfer to the expander shaft 13, the exhaust air fluid flow O₂′ leaving the fuel cell 1 at a pressure p₃ is further expanded and leaves the expander 11 via an outlet 14 at a pressure p₄, which may or may not be the ambient pressure p₁.

The expander shaft 13 is coupled to a shaft 17 of an electric motor 15 by means of a coupling 19. The electrical machine 15 is configured to be operated as a generator in a first operating mode and as a motor in a second operating mode.

A pressure control valve 21 is arranged between the outlet 5 of the fuel cell 1 and the inlet 12 of the expander 11, which can be variably regulated between an open position and a closed position in a plurality of intermediate positions and can be used to regulate the pressure on the side of the outlet 5 of the fuel cell 1.

Furthermore, a multi-port valve 23, for example a 3/2-way valve, is arranged between the outlet 5 of the fuel cell 1 and the inlet 12 of the expander 11, with which the inlet 12 of the expander 11 can be connected to the outlet 5 of the fuel cell 1, as shown in the figure, or to the inlet 3 of the fuel cell 1 or an inlet 2 of the compressor 7 in a fluid-conducting manner, whereby the inlet 12 then functions as an outlet.

The fuel cell system 100 also has a control unit arrangement 25, in the present embodiment example designed as a single control unit with a data memory 27 and a processor 29.

The control unit arrangement 25 is configured to actuate the compressor 7 and the expander 11 independently of one another such that one or more operating states of the fuel cell system 100 are directly influenced by actuating the expander 11. The control unit arrangement 25 is connected to the compressor 7 and the expander 11 in a signal-conducting manner for this purpose.

In addition, the control unit arrangement 25 is connected to the electrical machine 15 in a signal-conducting manner and is configured to control it either in the first operating mode or in the second operating mode. The electrical machine 15 and the expander 11 can also be an integrated unit that is controlled as such by the control unit arrangement 25.

Preferably, the control unit arrangement 25 is also configured to engage and disengage the clutch 19 between the expander 11 and the electrical machine 15.

The control unit arrangement 25 is preferably further configured to switch the multi-port valve 23 so that, in a normal operating mode as shown in the figure, it connects the outlet 5 of the fuel cell 1 in a fluid-conducting manner to the inlet 12 of the expander 11, or, in an auxiliary mode, it connects the inlet 12 of the expander 11, which then functions as an outlet, to either the inlet 3 of the fuel cell 1 or the inlet 2 of the compressor 7.

Further preferably, control unit arrangement 25 is configured to control, preferably regulate, pressure control valve 21 for setting a desired pressure at outlet 5 of fuel cell 1. If, for example, the fuel cell 1 has its own fuel cell controller 6, and that fuel cell controller 6 specifies what pressure should be present on the outlet 5 side of the fuel cell 1, the control unit arrangement 25 is preferably connected to the fuel cell controller 6 in a signal-conducting manner and is configured to receive corresponding control commands from the fuel cell controller 6 of the fuel cell 1.

The control unit arrangement 25 can be a dedicated control unit, as shown in the figure, or it can be designed as an arrangement of several control units. The control unit arrangement 25 can be implemented in hardware or software in the fuel cell 1, preferably as part of the fuel cell controller 6. Alternatively, the control unit arrangement 25 can also be implemented in the compressor control, the expander control or the control of the electrical machine 15 in hardware or software. Implementation in a control unit external to the fuel cell system 100 within the architecture of the commercial vehicle 200 is also possible.

Preferably, instructions for executing the method according to the invention are stored in the data memory 27, and the processor 29 is set up to execute these instructions. As an alternative to a permanently installed data memory 27, the control unit arrangement 25 can have an interface to an external data memory in which those commands are stored.

Due to the mechanical decoupling of the compressor shaft 9 and the expander shaft 13, the expander shaft 13 and the compressor shaft 9 can be operated at different speed levels, whereby it is preferable to select the speed level of the expander shaft 13 to be significantly lower than the speed level of the compressor shaft 9. The expander shaft 13 and the shaft 17 of the electric motor 15 may be directly coupled to each other or may be connected to each other via a transmission, wherein the transmission is preferably a step-up transmission. Further preferably, the transmission can optionally be shifted as a step-up transmission in normal operating mode, or as a step-down transmission, which then in auxiliary mode, i.e., when the electric motor 15 is operated as a motor, again acts as a step-down transmission in such a way that the rotational speed of the expander shaft 13 is greater than the rotational speed of the shaft 17 of the electric motor. In normal operating mode it is the other way around, then the rotational speed of the expander shaft 13 is lower than the rotational speed of the shaft 17 of the electric motor 15.

The operation of the fuel cell system 200 is explained in more detail below. The following embodiments have in common that the expander 11 is arranged to be operated at a variable operating point, i.e., at a variable rate of its rated power, and the control unit arrangement 25 is configured to control the expander 11 accordingly in order to support the fuel cell system 100 in different operating states. Some relevant operating states are described below as examples.

A first exemplary operating state concerns the ramp-up or loading of the fuel cell 1 from a lower power level, for example standstill, to a relatively higher power level. If such an increase command is registered, for example coming from the fuel cell control unit 6, the control unit arrangement 25 controls the compressor 7 accordingly to increase the rotational speed of the compressor shaft 9 in order to be able to supply more air to the fuel cell 1. Furthermore, in a first variant, the control unit arrangement 25 controls the expander 11 in an idle operating mode. For example, the clutch 19 can be opened for this purpose, whereby the expander shaft 13 continues to rotate, but without any significant rotational resistance, which means that no significant dynamic pressure builds up at the outlet 5 of the fuel cell 1. This makes it possible to achieve the desired rotational speed in the compressor 7 in a very short time and with comparatively few rotations of the compressor shaft 9. This improves the dynamics of the fuel cell system 1 and reduces wear on the bearings of the compressor shaft 9. Once the acceleration process has been completed, the clutch 19 can be closed again and the dynamic pressure required for operation of the fuel cell 1 can be set at the outlet 5 of the fuel cell 1. The expander can absorb energy from the exhaust air fluid flow O₂′ in a generally known manner and convert it into electrical energy by means of the electrical machine 15, which is operated as a generator in normal operating mode.

Alternatively, or additionally, the operating state of increasing the fuel cell power can be supported by the control unit arrangement 25 not setting the expander 11 to an idle operating mode, but instead setting the operating point of the expander 11 to a lower end range of the rated power intended for expander operation. In this area, the expander 11 offers little resistance to the incoming exhaust air fluid flow O₂′, and the compressor shaft 9 can be accelerated easily as described above.

The operating point can be shifted either by adjusting the pitch angle of the rotor elements (not shown) in the expander 11, if present, or by selectively actuating the electric motor 15, for example by actuating an inverter or similar power electronics element assigned to the electric motor 15. This can be done in a generally known manner.

A further operating state concerns the reduction of the electrical power to be generated by the fuel cell 1. If the electrical power output by the fuel cell 1 is to be reduced, for example to a standstill, or in any case from the current power level to a relatively lower power level, a command to decelerate the compressor shaft 9 is sent, for example again by the fuel cell control unit 6, to the control unit arrangement 25. The control unit arrangement 25 then controls the expander 11 in such a way that its operating point is shifted to an upper end range of the rated power specified for the expander 11. This can in turn be done by adjusting the pitch angle of the rotor elements (not shown) in the expander 11, if present, or by selectively actuating the electric motor 15, for example by actuating an inverter or similar power electronics element assigned to the electric motor 15. This generates a comparatively high dynamic pressure at the outlet 5 of the fuel cell 1, which represents a high resistance for the compressor 7. The higher the resistance for the compressor 7, the faster the rotational speed of the compressor shaft 9 will decrease if there is no counteracting drive work of the compressor shaft 9. The fact that the compressor shaft 9 comes to a standstill more quickly, i.e., after a smaller number of revolutions, in turn improves the dynamics of the system and also reduces wear in the compressor 7 because the compressor shaft 9 only has to perform a comparatively small number of revolutions before it comes to a standstill.

In a further operating mode, the fuel cell 1 is directly supported by actuating the expander 11, in which the expander 11 is controlled by the control unit arrangement 25 in such a way that the pressure on the side of the outlet 5 of the fuel cell 1 is specifically controlled, preferably regulated. As described above, the level of dynamic pressure on the side of the outlet 5 of the fuel cell 1 influences the extent of reactant depletion in a fuel cell, especially a fuel cell with several stacks, and there especially in the stacks through which the air O₂ later passes.

This actuating of the expander 11 to influence the dynamic pressure can be carried out in support of actuating the pressure control valve 21 or as a bridging measure in the event of a defect in the pressure control valve 21. The pressure control valve 21 can even be dispensed with if the expander 11 is dimensioned accordingly and the control algorithm is embodied accordingly. The pressure control valve 21 can also be structurally assigned to the fuel cell 1 or be a separate component in the fuel cell system 100. According to the invention, however, it can also be assigned to the expander 11, for example mounted on its inlet 12.

In a further operating mode, which concerns the failure or support case for the compressor 7 present in the fuel cell system 100, the control unit arrangement 25 controls the multi-port valve 23 to switch from the normal operating shift position shown in the figure to an auxiliary mode shift position, in which the inlet 12 of the expander 11 is connected in a fluid-conducting manner to the inlet 3 of the fuel cell 1, or alternatively to the inlet 2 of the compressor 7. The outlet 14 of the expander, from which the expanded fluid flow of the reacted exhaust air fluid flow O₂′ normally emerges, then serves as an inlet, and because the electric motor 15 operates as a motor in the now triggered auxiliary mode, the expander shaft 13 is driven by the shaft 17 of the electric motor 15 and ensures compression inside the expander, which then operates like a compressor. The inlet 12 of the compressor then acts as an outlet and feeds compressed air at a pressure p₅ to the corresponding inlet 3 of the fuel cell 1 or inlet 2 of the compressor 7. If compressor 7 itself is still functional, the expander acts as a first compressor stage for pre-compression and compressor 7 as a second compressor stage. If the compressor 7 fails, the expander 11 can take over the compressed air supply for the fuel cell 1, at least temporarily, at least as a “limp home” function.

The multi-port valve 23 can be a dedicated valve in the fuel cell system 100, but it can also be structurally connected to the expander 11.

The above discussions illustrate that the expander can provide a variety of functions that go far beyond the mere generation of electrical energy from the exhaust air fluid flow O₂′ of the fuel cell 1, and that the expander can be used to support the fuel cell system 100 in its general mode of operation in a variety of ways and make it more efficient.

### LIST OF REFERENCE NUMERALS

1 Fuel cell
2 Inlet, compressor
3 Inlet, fuel cell
5 Outlet, fuel cell
6 Fuel cell controller
7 Compressor
9 Compressor shaft
11 Expander
12 Inlet of the expander
13 Expander shaft
14 Outlet of the expander
15 Electric motor
17 Shaft of the electric motor
19 Clutch
21 Pressure control valve
23 Multi-port valve
25 Control unit arrangement
27 Data memory
29 Processor
100 Fuel cell system
200 Commercial vehicle

1. A fuel cell system (100) for a vehicle, comprising:
a fuel cell (1) with a cathode-side inlet (3) and a cathode-side outlet (5);
a compressor (7) connected in a fluid-conducting manner to the inlet (3) of the fuel cell (1) and having a compressor shaft (9);
an expander (11) having an expander shaft (13) and connected in a fluid-conducting manner to the outlet of the fuel cell (1); and
a control unit arrangement (25) for actuating the compressor (7) and the expander (11),
wherein the expander shaft (13) and the compressor shaft (9) are mechanically decoupled from one another, and
wherein the control unit arrangement (25) is configured to directly influence the operating state of the fuel cell system (100) by actuating the expander (11).

2. The fuel cell system (100) according to claim 1, wherein the expander (11) has an idling operating mode, and the control unit arrangement (25) is configured to switch the expander (11) to the idle operating mode during an acceleration process of the compressor (7).

3. The fuel cell system (100) according to claim 1, wherein the expander (11) is configured to be operated at a variable operating point.

4. The fuel cell system (100) according to claim 3, wherein the control unit arrangement (25) is configured to operate the expander (11) at an operating point in a range from 0% to 30% of its rated power, during an acceleration process of the compressor (7).

5. The fuel cell system (100) according to claim 3, wherein the control unit arrangement (25) is configured to operate the expander (11) at an operating point in an upper end range of its rated power, preferably in a range from 50% to 100% of its rated power, during a deceleration process of the compressor (7).

6. The fuel cell system (100) according to claim 3, wherein the control unit arrangement (25) is configured to control the operating point of the expander (11) for setting a desired outlet-side dynamic pressure between the fuel cell (1) and the expander (11).

7. The fuel cell system (100) according to claim 1, wherein:
the expander (11) is coupled to an electric motor (15) by means of the expander shaft (13), whereby the electric motor (15) can be operated optionally as a motor or as a generator; and
wherein the control unit arrangement (25) is configured to control the electric motor (15) in a normal operating mode as a generator and in an auxiliary mode as a motor.

8. The fuel cell system (100) according to claim 7, wherein:
the fuel cell system (100) has a multi-port valve (23) for the selective fluid-conducting connection of an inlet (12) of the expander (11) to the outlet of the fuel cell (1) or to the inlet (3) of the fuel cell (1); and
the control unit arrangement (25) is configured to control the multi-port valve (23) such that in normal operating mode the inlet (12) of the expander (11) is connected to the outlet of the fuel cell (1), and in auxiliary mode the inlet (12) of the expander (11), which then serves as an outlet, is connected in a fluid-conducting manner to the inlet (3) of the fuel cell (1) or the inlet of the compressor (7).

9. The fuel cell system (100) according to one of claims 3 to 8, characterized in that the expander (11) is designed such that it operates at lower speeds in its operating range than the compressor (7) in its operating range, wherein in particular the speed at rated power of the expander (11) is lower than the speed of the compressor (7) at rated power.

10. A method for operating a fuel cell system (100), the method comprising:
providing a fuel cell system comprising:
a fuel cell (1) with a cathode-side inlet (3) and a cathode-side outlet (5);
a compressor (7) connected in a fluid-conducting manner to the inlet (3) of the fuel cell (1) and having a compressor shaft (9); and
an expander (11) with an expander shaft (13), the expander connected in a fluid-conducting manner to the outlet of the fuel cell (1), wherein the expander shaft (13) and the compressor shaft (9) are mechanically decoupled from one another; and
actuating the compressor (7) and the expander (11), wherein the expander (11) is actuated such that an operating state of the fuel cell system (100) is directly influenced thereby

11. The method according to claim 10, comprising:
switching the expander (11) to the idle operating mode when the compressor (7) is accelerated.

12. The method according to claim 11, comprising one, several, or all of the steps of:
operating the expander (11) at a variable operating point;
operating the expander (11) at an operating point in a lower end range of a rated power when the compressor (7) is accelerated; and/or
operating the expander (11) at an operating point in an upper end range of a rated power when the compressor (7) is decelerated.

13. The method according to claim 10, comprising one, several, or all of the steps of:
controlling, preferably regulating, the operating point of the expander (11) for setting a desired outlet-side dynamic pressure between the fuel cell (1) and the expander (11);
actuating an electric motor (15) coupled to the expander (11) either in a normal operating mode as a generator or in an auxiliary mode as a motor; and/or
actuating a multi-port valve (23) such that in normal operating mode the inlet of the expander (11) is connected to the outlet (5) of the fuel cell (1), and in auxiliary mode the inlet of the expander (11), which then serves as an outlet, is connected to the inlet (3) of the fuel cell or the inlet (2) of the compressor (7).

14. A control unit arrangement (25) for a fuel cell system (100) of a vehicle wherein the control unit arrangement (25) is configured to carry out the method according to claim 10.

15. The method according to claim 12, wherein the lower end range of the rated power is in a range of 0% to 30% of the rated power.

16. The method according to claim 15, wherein the upper end range of the rated power is in a range of 50% to 100% of the rated power.

17. The method according to claim 12, wherein the upper end range of the rated power is in a range of 50% to 100% of the rated power.
